(19) United States
(12) Patent Application Publication
(10) Pub. No.: US 2017/0091993 A1
(43) Pub. Date: Mar. 30, 2017

(54) 3D Model Generation From Map Data and User Interface

(71) Applicant: Microsoft Technology Licensing, LLC, Redmond, WA (US)

(72) Inventors: Felix G.T.I. Andrew, Seattle, WA (US); Duncan Murray Lawler, Bothell, WA (US); Kristofer N. Iverson, Redmond, WA (US); Apurva Ashvinkumar Thanky, Redmond, WA (US)

(21) Appl. No.: 15/052,069

(22) Filed: Feb. 24, 2016

Related U.S. Application Data
(60) Provisional application No. 62/233,271, filed on Sep. 25, 2015.
(60) Provisional application No. 62/233,242, filed on Sep. 25, 2015.

(51) Int. Cl. G06T 17/05; G06F 3/0481

(52) U.S. Cl. CPC G06T 17/05; G06F 3/04812; G06T 2200/24

(57) ABSTRACT

Methods and systems are described for selecting, via a graphical user interface, map data to generate a three-dimensional (3D) model based on the selected map data. In one aspect, a method may include displaying, via the graphical use interface, a visual representation of map data. A selection of the map data may be received by the graphical user interface via a selector. The received selection of the map data may be modified to correspond to at least one of a boundary or an object in the map data. A 3D model of the modified selection of the map data may be generated and displayed by the graphical user interface. In some aspects, modifying the received selection of map data may be performed concurrently with receiving the selection of the map data, such as including moving the selector to at least one of the boundary or the object.

### CROSS REFERENCE TO RELATED APPLICATIONS

This application claims priority to U.S. Provisional Patent Application No. 62/233,242, filed Sep. 25, 2015, and U.S. Provisional Patent Application No. 62/233,271, filed Sep. 25, 2015, the entirety of which are incorporated herein by reference.

### TECHNICAL FIELD

This disclosure relates generally to translating map data into a three-dimensional (3D) model, and more specifically to translating map data into a 3D model for 3D printing, virtual rendering, and other 3D rendering/realization technologies.

### BACKGROUND

Current mapping programs and applications provide a useful tool for navigation, providing aerial views of locations, and even modeled three-dimensional views and images of selectable features, locations, areas, etc. These mapping applications generally utilize a cartography standard or projection, for example a version of the World Geodetic System (WGS), such as WGS-84, which is the reference coordinate system used by the Global Positioning System (GPS), the Mercator projection, and other cartography standards or projection models. Such systems, and mapping applications that use these systems, generally apply two-dimensional image representations of, for example, buildings, terrain, etc., to a coordinate system, to generate pictorial representations of objects on or within a given map. In some cases, three-dimensional information may be included in a section of map, but these portions of three-dimensional data may be limited or otherwise not continuous. As a result, these applications, and the data used and generated by these applications, generally do not completely define a three-dimensional space. Accordingly, generating a truly three-dimensional representation of data from map data, and particularly, a complete and continuous three-dimensional representation of a portion of space from map data, presents particular challenges.

### SUMMARY

Illustrative examples of the disclosure include, without limitation, methods, systems, and various devices. In one aspect, techniques for selecting, via a graphical user interface, map data to generate a three-dimensional (3D) model based on the selected map data may include displaying, via the graphical use interface, a visual representation of map data. A selection of the map data may be received by the graphical user interface via a selector. The received selection of the map data may be modified to correspond to at least one of a boundary or an object in the map data. A 3D model of the modified selection of the map data may be generated and displayed by the graphical user interface.

Other features of the systems and methods are described below. The features, functions, and advantages can be achieved independently in various examples or may be combined in yet other examples, further details of which can be seen with reference to the following description and drawings.

### BRIEF DESCRIPTION OF THE DRAWINGS

Embodiments of the present disclosure will be described more fully hereinafter with reference to the accompanying drawings, in which:

FIG. 1 depicts an example translation of map data into a 3D model.

FIG. 2A depicts an example translation of map data into a 3D model using a mapping application and a 3D modeling application.

FIG. 2B depicts an example of a User Interface of a 3D modeling application for translating map data into a 3D model.

FIG. 2C depicts an example of a User Interface of a 3D modeling application for selecting map data for translation into a 3D model.

FIG. 2D depicts another example of a User Interface of a 3D modeling application for selecting map data for translation into a 3D model.

FIG. 3 depicts an example process of dividing a map of the world into tiles for use in generating a 3D model.

FIG. 4 depicts an example of tile subdivision and related texture atlases that may be used in generating a 3D model.

FIG. 5 depicts an example diagram of a texture atlas overlaid onto a coordinate or tile system, and color information added to generate a tile skirt.

FIG. 6 depicts an example of a view frustum that may be used in translating map data into a 3D model.

FIG. 7 depicts an example of map data having tiles of different resolution for use in generating a 3D model.

FIGS. 8, 9A, and 9B depicts example operational procedures for converting map data into a 3D model.

FIG. 10 depicts an example general purpose computing environment in which in which the techniques described herein may be embodied.

FIG. 11 depicts an example operational procedure for receiving a selection of map data and translating the selection into a 3D model via a User Interface.

### DETAILED DESCRIPTION OF ILLUSTRATIVE EMBODIMENTS

Systems and techniques are described herein for translating map or other similar data into a three-dimensional (3D) model. In some aspects, the translated data may be used and/or further modified for a number of applications, such as 3D printing, 3D modeling, 3D virtualization, and various other applications. The described techniques, which may be referred to herein as 3D translation techniques, may include converting map data, such as WGS-84 data and/or Mercator projection data, into a 3 dimensional model of a portion of space, for example, that may be selected by a user via a user interface provided in conjunction with one or more mapping applications or programs. The portion of map space selected or otherwise defined via the user interface may correspond to one or more tiles of Mercator projection data, or blocks or areas of another coordinate system. These tiles or blocks may be retrieved and then used to define boundaries of the 3D model or representation. The tiles or blocks of data may be modified from a global space orientation (e.g., WGS-84) or other orientation system into a localized orientation, for example, corresponding to a view or perspective selected by a user. The localized or local orientation of the map tiles or blocks may then be further modified, as described below, to generate a fully enclosed or defined three-dimensional volume of space, including a bottom or ground plane, sides, or tile skirts, and a top surface or mesh, that includes height variation, texture, and color, for example.

When map data is translated to a 3D model, there may be gaps or absences of data in places, for example, due to the map data not containing complete 3D data (e.g., the image data of the map was only obtained from a limited number of angles or perspectives). In such cases, it may not be possible to render the 3D model in applications such as 3D printing because the application may require a complete representation of the portion of the map that is being rendered without gaps or missing information. In this scenario, gaps or holes in the map data may be filled in to generate a mesh or top surface of the 3D model that is continuous. A ground plane and a skirt or side edges may be generated and added to the mesh to create a 3D representation of map and image data. Texture and color may be applied to the 3D model, for example, by manipulating texture and color data included in the map data, during one or more steps of translating the map data into a 3D model. In some aspects, gaps or the absence of data corresponding to features or portions of the selected space may be extrapolated from known data corresponding to spaces or features proximal to each gap. In this way, a continuous, and visually detailed 3D model may be created from map data, for example, that may be provided by various mapping applications.

In one example, the map data may include WGS-84 data (e.g., relative to global space), Mercator projection data and the like corresponding to one or more tiles obtained from a mapping application, such as Bing, for example, corresponding to a section or portion of a map. Each tile may be associated with information describing the surface properties of the tile, including height information, texture, color, etc. The described techniques may include translating each tile into a local space, defined such that the origin (e.g., in Cartesian or other coordinate system) is positioned in the place of the camera in a current view, for example, in the mapping application. Next, the centroid of each tile may be determined, for example, in terms of latitude and longitude. Each tile from the map data such as WGS-84 global space and/or the Mercator projection data, may be rotated into a local space where the normal to the Earth (up vector) at the determined centroid point defines the positive z-axis, the positive y-axis points north, and the positive x-axis point east (e.g., to the right). In some cases, for example, where the end application or use of the 3D model is associated with a different coordinate system, it may be preferable to match or convert the 3D model into the target coordinate system (e.g., converting to a left-handed coordinate system or right-handed coordinate system).

In some cases, where multiple map tiles define the selected space for 3D modeling, the tiles may not define an actual volume, for example, if the map data is based on or associated with incomplete or insufficient information. For example, there may be gaps in the data, one or more tiles may not be directly aligned or may not be continuous, etc. In this scenario, the translation process may include attaching or connecting the edges of different portions or segments to define a continuous space such that a volume is defined. For example, each portion of map data may be translated into a volume corresponding to a section (e.g., square) of a ground plane. In one example, the ground plane may be defined by or correspond to a mesh (surface of the area). Combining multiple volumes of map data corresponding to mesh segments, may create a manifold mesh. Each mesh segment may inherit texture and color information from the map data, adjusted and/or modified to fit one or more 3D shapes. Gaps or absences of data between one or more mesh segments may then be filled in using adjacent or proximate texture, color, volumetric information, etc.

In one example, a user interface may be provided in conjunction with a 3D modeling application. The user interface may include various controls for navigating and selecting map data to translate into a 3D model. The user interface may additionally include various controls for editing and manipulating a 3D model, once generated. The user interface may display a representation of map data, including traditional 2D maps, simulated 3D maps, and other maps, including maps provided by existing mapping and navigation applications. In one implementation, the user interface may operate in conjunction with a touch interface (e.g., touch screen) that enables panning, zooming, selecting an area of map data, and other actions, in relation to the displayed map data via a number of configurable swipe gestures. In another implementation, the user interface may operate without the need for any touch screen interface, for example, utilizing traditional input devices (mouse, keyboard, etc.). In one implementation, the user interface may operate in conjunction with other gesture input devices not limited to a touch interface, such as body movements, eye movements, etc.

In one example, to define the 3D model as a volume, sides or a skirt may be generated and applied to the edges of the 3D model, e.g., as vertical walls. In some aspects color, texture, and/or volumetric features corresponding to proximate spaces or features may be applied to the skirt, for example to generate a more visually appealing model.

In one example, a full globe (e.g., Earth) or a substantial portion thereof may be modeled. In this scenario, in order to generate and/or display a complete spherical-shape, view frustum and back-culling may be disabled in the map application or 3D modeling application, to enable more complete modeling of the 3D world.

In one example, objects or boundaries may be identified and extracted from the map data, such as roads, points of interest, buildings, road signs, fences, geographic or terrain features, such as lakes, rivers, etc., and so on. These objects may be defined as distinct entities, and generated in the 3D model having distinct properties, including dimension information, texture and color information, etc. In this way, the generated 3D model may include a more accurate representation of the real world. The 3D model may then be printed by a 3D printer with an identified object having the associated property or properties, for example, to more distinctly define the identified object. In some aspects, these distinct objects may be used in defining the area of map data to translate to a 3D model. For example, map tiles or areas of map data (not defined by tiles, for example) may be selected to include complete objects, boundaries and/or selections of one or more tiles for the 3D model may be modified to include complete objects, etc.

In some aspects, labels of identified locations or features in the map data (building names, business names, street names, names of rivers, mountains, etc.), labels of favorite places, pins or other markers indicating previously traveled or visited places, and so on, may be included in or added to the map data. The label data may, in some aspects, be retrieved with the map data (e.g., from the same source, such as one or more mapping applications), or may be obtained from other sources and cross-referenced to the map data to provide accurate and automatically generated label data. In some cases, a UI associated with the mapping application may include an option to display and/or access or import labels or identification information. In yet some aspects, the UI may enable individual addition/configuration of labels or other identification information. In some cases, this identification data may be included in the 3D model, such that the label or marker of a location or a favorite place may be displayed at the actual location or on the actual object (e.g., the name of a street written on the street in the 3D model, or the name of building written on the building itself). The 3D model may then be printed by a 3D printer with the labels or identification information.

In one example, the mesh data may be automatically formatted to be usable by a 3D printer. In some aspects, this may include translating the 3D model to sit above a build plane of a 3D printer, auto-centering of the 3D model, and scaling the 3D model to conform to the bounds or limits of the 3D printer (e.g., on the scale of millimeters).

In another example, the 3D model may be generated or re-formatted for use with a 3D virtualization system, such as a device providing augmented reality or full virtual reality. One such device may be a holographic computing device that is configured to render the 3D model as a hologram on a display surface that may also allow visualization of physical real-world elements. In another example, the 3D model may be rendered on an immersive virtual reality system. In some embodiments, the user may be enabled to navigate through portions of the rendered 3D model or change characteristics of the rendered 3D model.

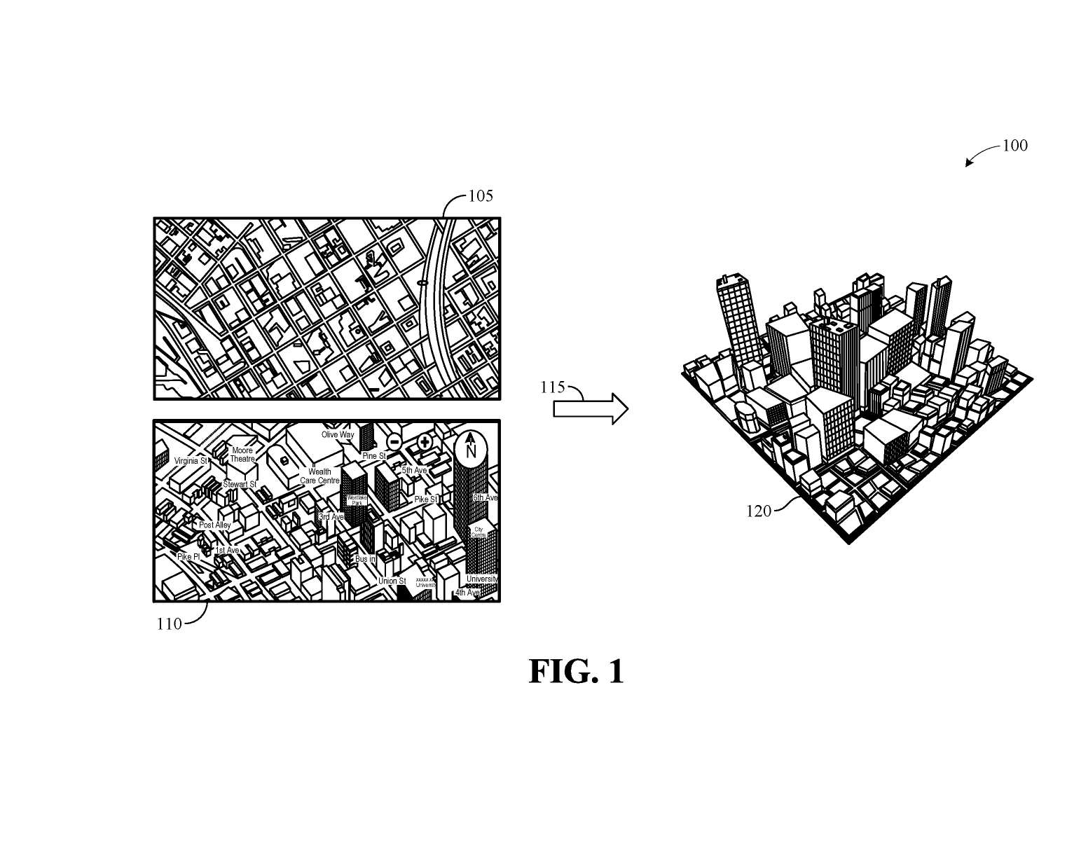

FIG. 1 illustrates an example diagram of a translation 115 of map data 105, 110, into a 3D model 120. The map data may include aerial map data 105 in two dimensions, including image data or graphic representations thereof, perspective or partial 3D map data 110, or other types of map data not shown. The map data 105, 110 may correspond to any size of area or volume of space represented by a map or other representation of map information. The map data 105, 110 may be translated and transformed into a 3D model 120, via operation 115, which will be described in greater detail below. From a high level, operation 115 may include translating the map data 105, 110 into a local space, scaling the map data, and connecting the surface layer defined by the map data into a mesh, whereby gaps in the mesh are then connected or filled in, to define a continuous surface and a volume.

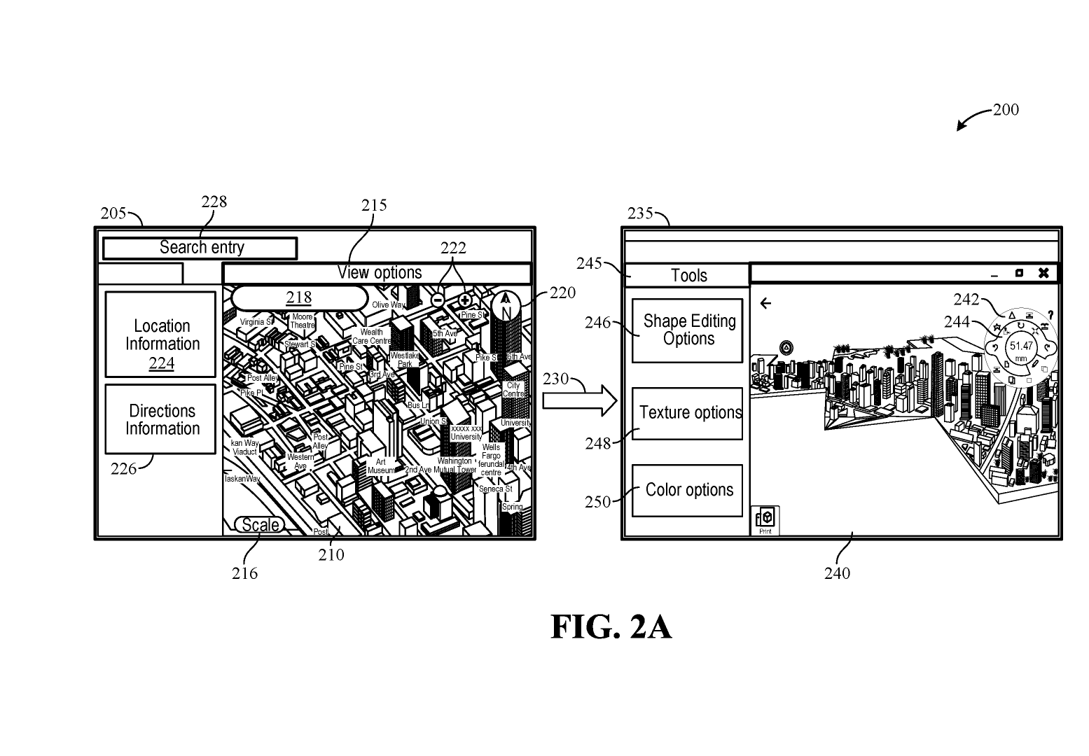

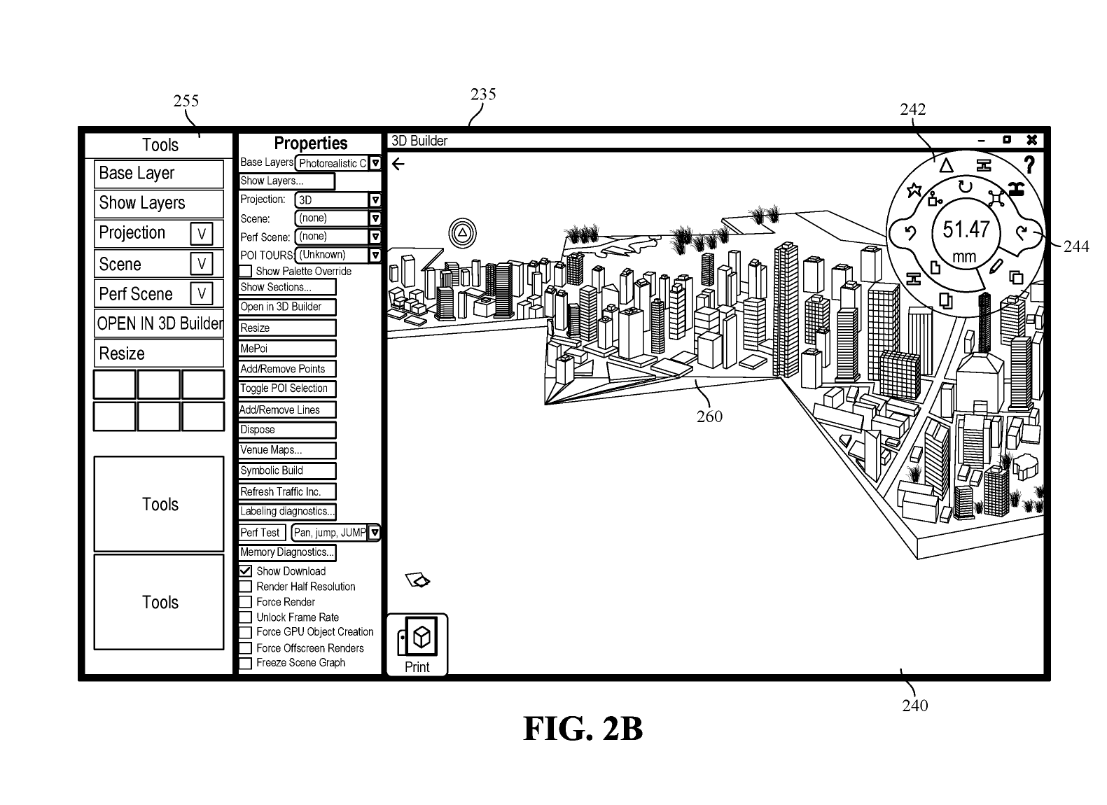

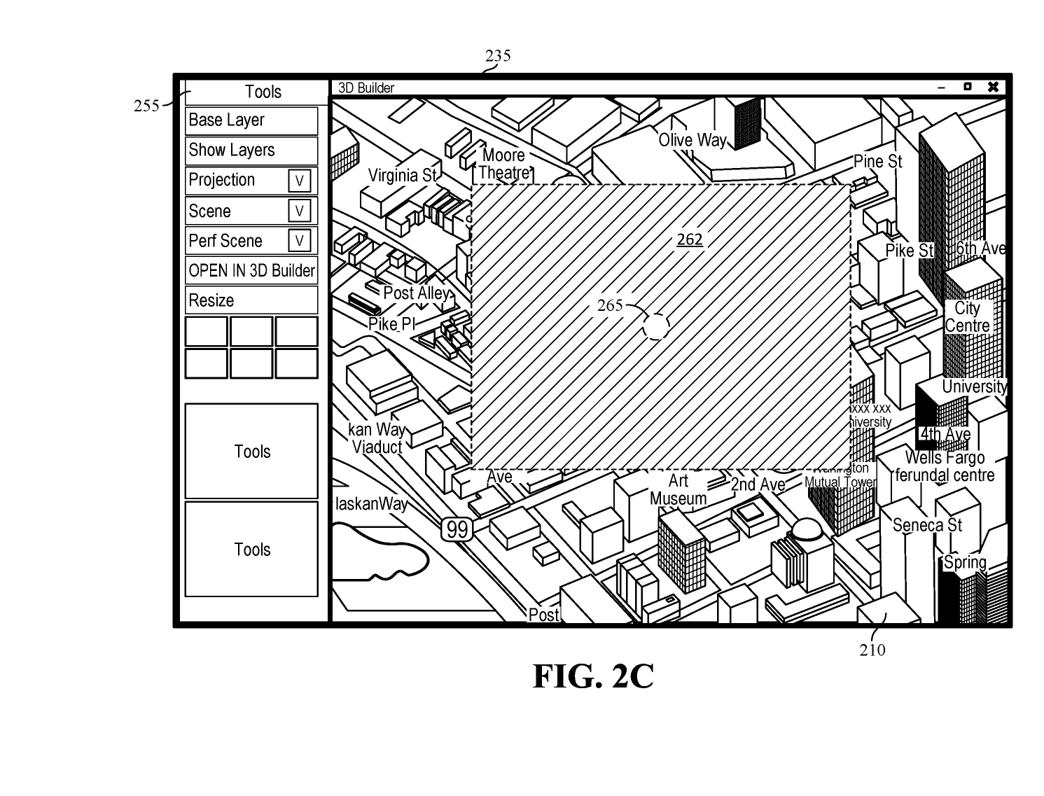

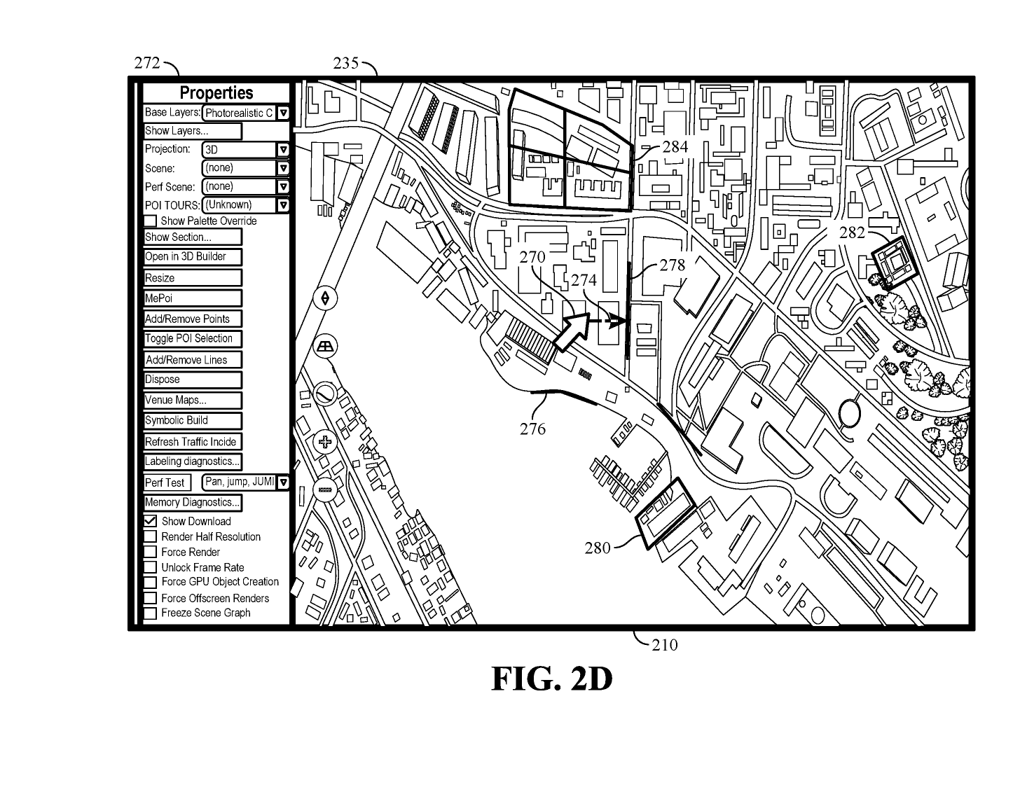

FIG. 2A illustrates an example implementation of the process described in FIG. 1, where map data 210 from a mapping or navigation program or application 205 is selected and then translated 230 into a 3D model 240, for example, within a 3D mapping program or application 235. The mapping application 205 may include any number of controls, features, interfaces, selection options, etc., 215-228, for selecting maps of physical locations to view, zooming in and out of selected areas or locations, providing navigation functions, identifying locations, points of interest (e.g., businesses), and so on. In one aspect, a selection of a certain area or volume of map data may be received by the mapping application 205. Upon receiving an instruction to generate a 3D model, the application 205 may call, or another program (e.g., the OS of the computing device upon which the application 205 is running) may call, the 3D modeling application 235. The 3D modeling application 235 may translate the selected portion of map data into a 3D model 240, and display the 3D model 240 in a 3D mapping and editing interface 235.

In some examples, after the 3D model 240 has been generated, the interface may provide controls for editing or changing the 3D model 240. The controls may include zooming 242, changing perspective via a compass 244, editing certain shapes or objects in the 3D model 246, options for modifying or adding addition texture information 248, color editing options 250, and so on. The 3D model 240 may be generated in such a way as to enable full panning around the 3D model 240 in virtual space.

While mapping application and interface 205 is illustrated and described as being different from the 3D modeling application and interface 235, it should be appreciated, that in some aspects, a single interface, provided by a single application, may be implemented to a similar effect. For example, as illustrated in FIG. 2B, a single 3D modeling application 235 may obtain or have access to full map data covering the Earth, or any subset thereof. The application 235 may provide a user interface that displays the map data in a graphical format 210 and tools 255 for selecting an area or space of the graphical representation for translation to a 3D model 240, and for editing the 3D model, once generated.

The 3D model application user interface 235 may provide various tools for modifying the 3D model. In one example, the user interface 235 may provide for selection or modification of resolution information or level of detail to include in various portions of the 3D model. In some examples, the user interface 235 may provide options for adjusting visual features of tile skirts 260, for example, including modifying color, texture, or other visual aspects of one or more tile skirts 260. The user interface may additionally or alternatively provide options for modifying color, texture, height, and other visual information of the 3D model. In some examples, the user interface 235 may provide options for combining 3D models of distinct geographic areas, for example, for visual comparison or other purposes. In some aspects, the user interface 235 may provide a feature smoothing function, for example, to clean up edges, surfaces, etc., where higher resolution map data may not be available, for artistic effect, or for other purposes.

FIG. 2C illustrates the application and UI 235 of FIG. 2B, displaying map data 210 instead of 3D model 240. Portions of the rendered 2D map 210 may be selected for translation to the 3D model. In one embodiment, a user may use various user input means to make the selection. For example, the user may use a graphical pointer tool such as a mouse, or a touch device such as a finger or pen on a touchscreen. In some aspects, the input means may include gesture input, such as a user's hand or body movement, eye movement, etc., that may be sensed using devices such as cameras. The user may draw or otherwise select an area, such as area 262, for translation. In another embodiment, the selection may be made by inference from the context of a mapping application. For example, the portion of a map that is rendered on the user display may be automatically selected for translation in response to an indication that the translation to the 3D model is initiated. The indication may be a user selection of a command to initiate the translation. In one example, a centroid of the rendered map data 210 may be used as a reference point of automatic map data selection for translation to a 3D model. An area 262, for example, may then be defined around the centroid 265, for translation to the 3D model. The area 262 may be of various shapes and sizes, and in some implementations, may be selected based on attributes of the map data itself, such as defining the area 262 along street lines, or other data, such as texture, color, object data, etc.

FIG. 2D illustrates another example of the UI 235 of FIG. 2C, displaying map data 210. The 3D model application user interface 235 may provide various tools for selecting features, objects, areas, spaces, etc., within a display of map data for translation to a 3D model. In one aspect, the user interface 235 may provide for a cursor 270, which may be controlled via a physical device, touch input, gesture input, etc., for selecting and/or manually defining an area of the displayed map data to be translated into a 3D model. Via cursor 270, an area may be drawn around an area for translation into a 3D model. In some aspects, various controls, for example, in a properties area 272 of the user interface 235, may be provided that enable further configuration of automatic behavior of the cursor 270, implemented during selection of an area for translation. For example, the user interface 235 may enable selection of automatic movement 274 (e.g., snap) of the cursor 270 to defined or recognized boundaries in the map data, such as roads, alley ways, shorelines, edges of buildings, or other identifiable boundaries 276-278. In one aspect, the types of boundaries that the cursor is instructed to automatically move to when in close proximity may be separately selected and configured. In one aspect, the user interface 235 may be configured to automatically select city blocks, or other readily identifiable areas for selection, such as area 280. In some aspects, for example, when a large area is displayed in the user interface 235, the cursor 270 may be configured to automatically select a logical subset of the displayed map data for selection, such as city, county, or other government organizational boundaries, geographic based boundaries such as rivers, mountains, lakes, etc. In some cases, the user interface may include a selection option to display boundary lines of tiles defined by the map data (e.g., according to WGS 84 and/or Mercator projection data), to enable more informed selection of an area to be translated.

In some examples, objects may be identified in the map data to enable selection of individual objects or groups of objects for translation into a 3D model. In some aspects, an object may be identified automatically by the 3D modeling application 235, such as based on map and other data. The user interface 235 may provide a selection option to enable auto-snapping to individual objects, such as buildings or other objects. In some aspects, a user may roughly define an object using cursor 270, such as building 282, whereby the application 235 may obtain map data proximate to the selected area to obtain relevant data relating to the selected object for translating into a 3D model.

In one example, the user may select an area using cursor 270 or other section means corresponding to a single tile of map data (e.g., as defined by the WGS 84 and/or Mercator projection data) 284. The user interface 235 may provide for a selection to subdivide the tile 284 into 4 tiles (or another number of tiles configurable by the user), for example, to enable individual modification of different portions of the 3D model to be generated corresponding to the one or more of the generated tiles.

While only a few example controls provided by user interface 235 are described above, it should be appreciated that various other features may be provided, including resolution configuration of areas to be translated into a 3D model, point of interest identification and selection, and other features, for example, illustrated in the properties area 272.

In one example, the map data provided by the mapping application may be generated via the techniques described below. In another example, the map data may be generated, obtained, or accessed by the 3D modeling application, such that the 3D modeling application can operate independently of a mapping application. In either case, the techniques for translating map data into a 3D model may utilize specific features of the map data and the way the map data is formatted and/or generated. It should be appreciated, that the specific implementation described below is only given by way of example. The techniques for translating map data into a 3D model are applicable to various forms and types of map or geographic data. For example, map data formatted using other types of projections, (e.g., other than a Mercator projection), may be similarly translated using a coordinate system as a reference, such as latitude and longitude coordinates, or other systems and schemes used for organizing, manipulating, and presenting map data.

In one example, the map data may include WGS-84 data (e.g., relative to global space) and Mercator projection data corresponding to one or more tiles obtained from a mapping application, such as Bing, corresponding to a section or portion of a map. The map data may be a combination of a large number of aerial photos, for example, captures by aircraft flying over metropolitan areas taken at different angle. In a post-processing stage, this large amount of image data (e.g., terabytes) is matched to locate regions of pixels that are common to each image. Using triangulation based on the known positions and look angles of the source images, a 3D point cloud is created. This point cloud may then be triangulated into a single surface mesh.

In order to obtain color data for the mesh, each triangle defining the mesh may be examined, and the source image with the best view of that triangle selected from which to obtain image pixels. The source image pixels may then be copied into a two-dimensional bitmap which may define a texture atlas for the mesh. This textured mesh may then be divided up into sections for efficient storage and delivery, for example, to a mapping and/or 3D modeling application on a client device. The process of dividing up sections of the mesh may generate a number of sections referred to as tiles. As the earth is mostly a sphere, it is difficult to divide into a regular, rectangular grid. In order to simplify this process, a geographic projection may be used to turn a spherical surface into a two-dimensional surface, which is easier to subdivide. The tile system may be based on the Mercator projection which converts any spherical coordinate in latitude/longitude into a two-dimensional Mercator coordinate. In Mercator coordinates, the world can be divided up into square chunks called tiles.

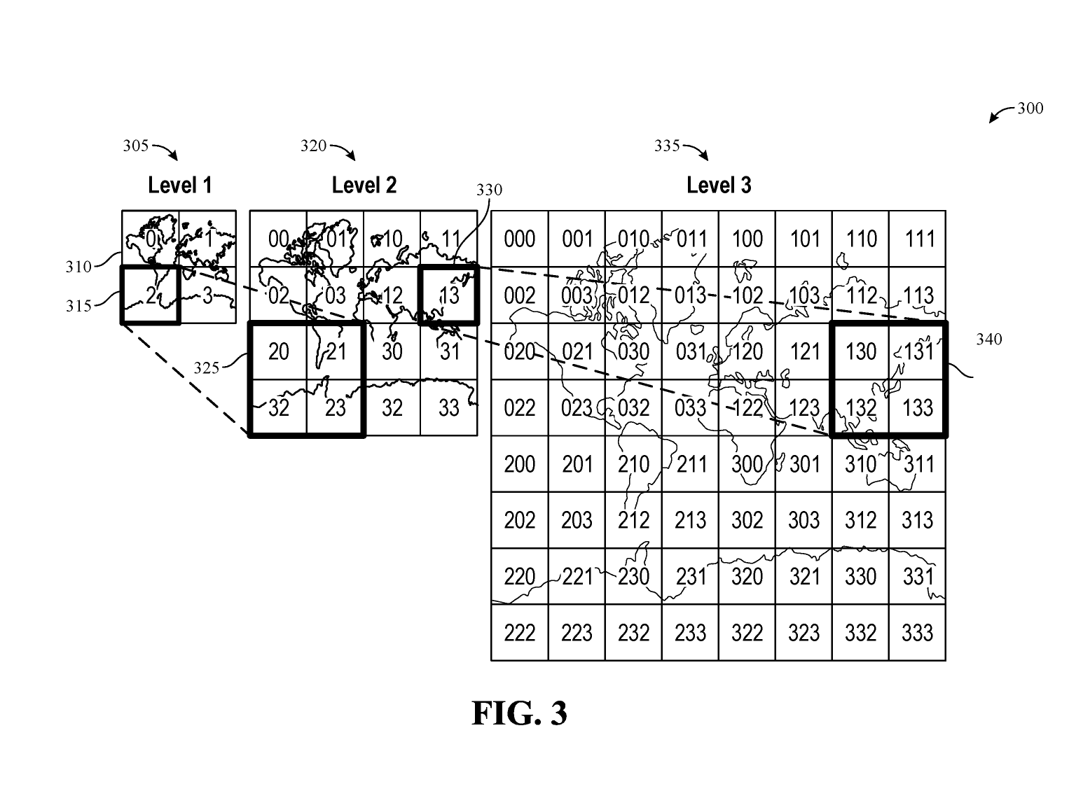

An example process 300 of breaking the globe into a number of tiles is illustrated in FIG. 3. It should be appreciated that process 300 may similarly be applicable to other representations of map data, such that do not include the entire globe, or include more than the globe, for example. Process 300 may begin with one tile defining the whole world. This single tile may then be subdivided into 4 tiles 310 in level 1 305 of process 300. The subdividing process may be repeated with each tile, such as tile 315, dividing into 4 tiles 325 in a second level 320, a tile 330 in level 2 320 subsequently divided into 4 tiles 340 in level 3 335, etc. At each level of subdivision, there are an increasing number of tile subdivisions filling the whole model. In one example, this process may be repeated up to 20 times or levels of detail. In one example, the source mesh may be divided along the level 20 tile boundaries. Each tile boundary may follow straight lines in Mercator space, which in real-world space will be along North-South and East-West lines.

In some examples, the lines separating the tiles may cut through the mesh in arbitrary places. The process may result in a building being cut in half, for example. This process may create a problem if a tile is separated and displayed apart form an adjacent tile, such that an empty shell would be exposed with nothing defining the edge of the building or terrain feature, etc. In some examples, in order to address this problem, tile skirts may be created to in essence, add vertical walls to the edges of tiles. Tile skirts may be created along the intersection of the plane forming the tile boundary (which goes through the center of the earth) with the surface mesh. The tile skirt may extend down to a local minimum, which may be determined or computed for a specific region. In some aspects, colors and/or textures may also be assigned to this plane to roughly match the colors or textures of the surface mesh along the edge. An example of tiles skirts 260 are provided in 3D model 240 illustrated in FIG. 2. In other embodiments, the lines separating the tiles may be adjusted to avoid cutting through certain objects such as buildings. For example, the lines separating the tiles may be adjusted to run through streets and alleys. In some embodiments the objects through which cutting is to be avoided may be selectable (e.g., prioritized).

For each tile, a texture atlas may be created from the master source atlas that contains all the surface coloring and other features that are referenced by any triangle in a particular tile mesh. In one example, this data set may correspond to the highest level of detail that may be shown in the map application 205/3D modeling application 235, and is typically several hundred gigabytes in size for an average city. In order to display this efficiently in a client application 205, 235, lower levels of detail may be needed to show larger areas or spaces on a single screen. In one example, meshes and textures from four adjacent tiles are combined into a single mesh for the one tile that was the parent tile in the tile hierarchy. The mesh may then be simplified by removing vertices and collapsing triangles based on some error tolerance. The texture atlas may be resampled to a lower resolution. The resulting tile will typically be similar in size to each of the 4 sub-tiles, but cover the same area as all four combined. The process is then repeated for successive levels of detail. The detailed city data described above may be created for high-population urban areas where more data may be available.

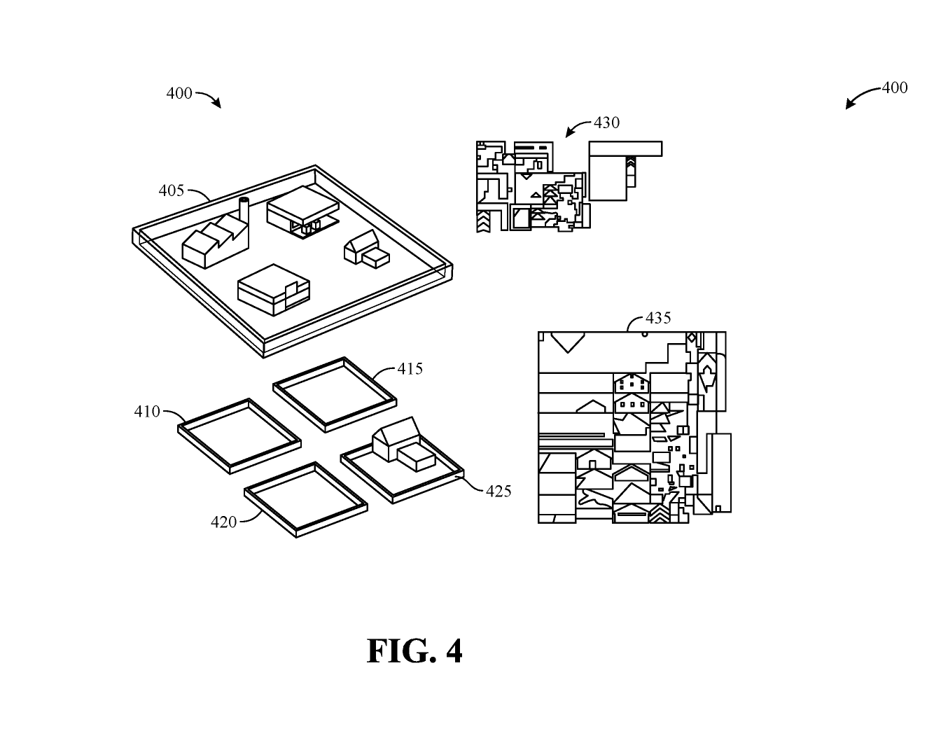

FIG. 4 illustrates an example relationship 400 between a single master tile 405 and 4 tiles 410-425 that are subdivisions of the master tile 405. The texture atlas 430 corresponding to the master tile 405 is illustrated to the right of master tile 405 and the texture atlas 435 corresponding to tile 425 is illustrated to the right of tile 425. Texture atlas 435 may correspond to a higher resolution than texture map 430. Via this relationship, texture atlas information corresponding to various portions or areas of a map and the 3D models that may be generated from that data may be scaled, for example, to fit within a display screen of a client device, for example, corresponding to a certain pixel resolution. This relationship may also be used to vary levels of detail of certain portions of tiles of a 3D model, for example, when exported to a virtual 3D application (this may not be as preferable in the 3D printing context).

In some aspects, map data outside of, for example, metropolitan areas or areas of high interest, may be generated differently. A global set of height data may be available at medium-low resolution. This data may not contain much surface detail, but may include large terrain features like mountains and hills. This data may correspond to a 2-dimensional bitmap where each pixel includes a grayscale single-channel value. The value may represent the height of the terrain above the WGS-84 ellipsoid model of the earth. This height-bitmap may be cut up into the same Mercator tiles mentioned above. The result is a similar level of detail system that was created for the mesh data. The color information/texture for this data may come from aerial or satellite imagery (which may also be stored in the same tile system).

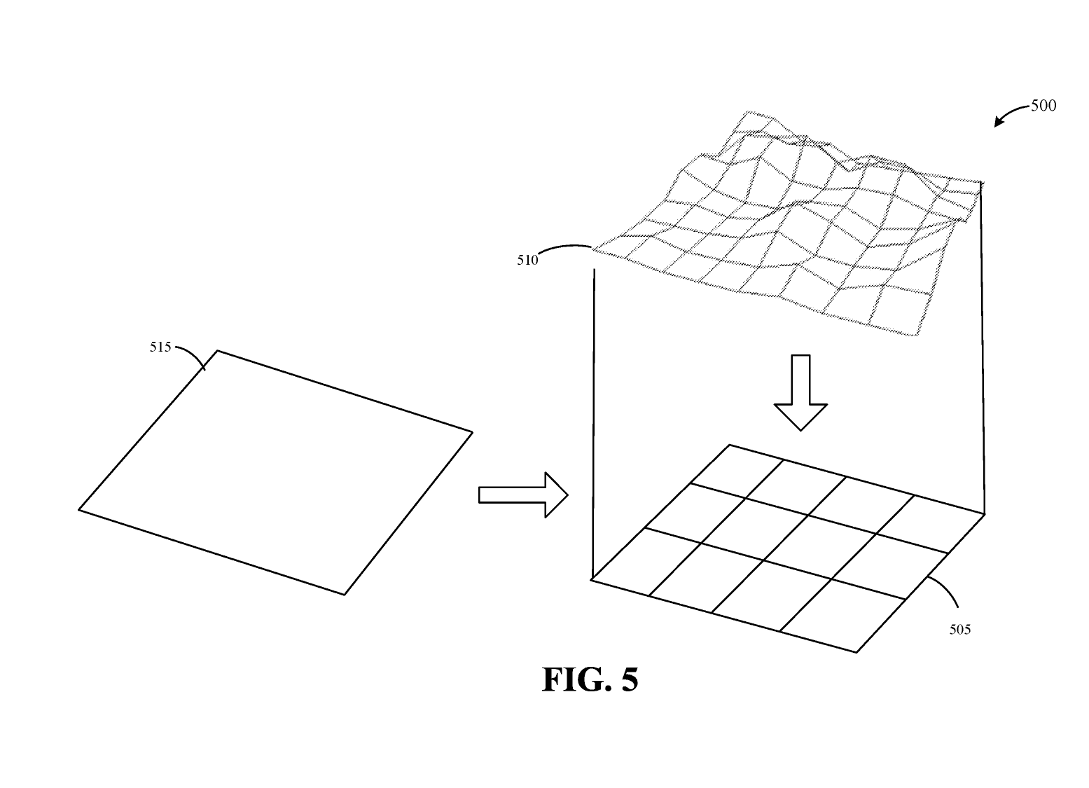

Upon determination of a selection of map data to translate into a 3D model, the 3D modeling application 235 may obtain the height bitmap image and then use it to create a mesh using a regular subdivision connecting triangles between each heightmap vertex. The aerial or satellite texture may then mapped to the mesh. Like the 3D mesh data, this generated textured mesh may be a simple shell, and may not define a full 3D model or volume. A similar operation may be performed to create a skirt along the edge of the tile by extruding a plane down towards the center of the earth. This extrusion is colored using the edge pixels of the source aerial texture. A representation of this process is illustrated in FIG. 5, with layer 505 representing a plurality of tiles, layer 510 representing the height bitmap used to create the mesh (in some cases, layer 510 may include partial 3D data as well), and data 515, including color and/or texture information, being applied to the boundary or edges of the combined mesh and tile layers 505, 515 to form the tile skirts.

Gaps in textures for a 3D model may be filled in order to provide a complete and appealing model. In some embodiments, the texture information for a part of a tile may be determined when such texture information is not readily accessible or available. The image information may be analyzed so that features in the image information such as colors, textures, and objects may be identified. For example, an image recognition algorithm may be used to extract features and match the extracted features to recognize colors, textures, and objects in the image. Such an algorithm may be configured to examine and process individual pixels of an image and determine feature properties using pattern recognition and other techniques. When a texture is determined, characteristics of the texture may be interpolated across the surface that has a gap in texture information.

In some aspects, the texture of an adjoining portion of the map data, such as in such as an adjacent map tile, may be used to connect a gap or hole in the map data. In one example, u,v coordinates of a 2D texture image (e.g., of the map data) may be extended across triangles of a nearby mesh that does not contain texture data. Another example may include applying vertex or face colors in a pattern similar to a nearby section of the surface mesh of the map data. In yet one example, a gradient may be applied across a mesh/triangle face without texture data, where the gradient starts with the color at one edge, and changes to the or another color at another edge.

In some embodiments, recognized features may be used as a point of reference to which other features can be related or against which features can be measured. The identified features may be used as a reference for image scaling or to correlate various other features in the image information.

In one aspect, translating global map data to localized data for the purposed of building the 3D model may including extracting geometry hooks from the map data and related data (e.g., associated with objects identified from the map data, such as roads, street names, points of interest, buildings, such as airports, schools, etc., fences, signs, or points or pins indicated or placed on a map, etc.) and then using those geometry hooks to determine which geometry to render. An example rendering algorithm is described below.

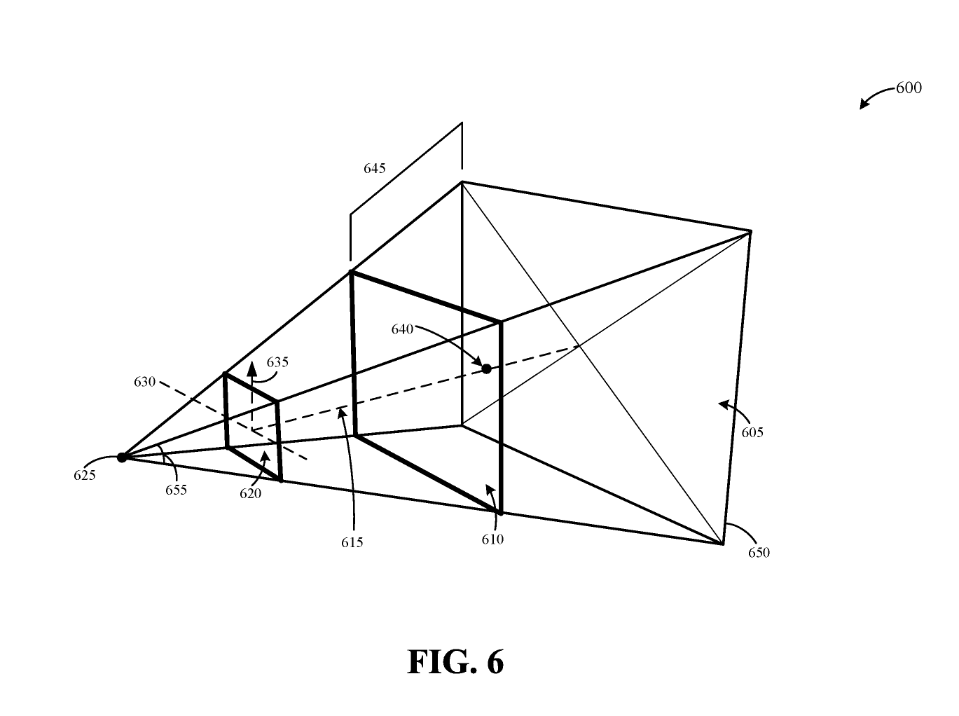

The mapping program may maintain a virtual view location, for example, of a client device using the mapping program as a navigation tool. In some examples, mapping information may be similarly associated with a view location or perspective apart from a mapping program or application. In either case, the view location may be specified in terms of a location near the earth and an orientation. These coordinates can be specified in multiple ways, but may typically include a Cartesian coordinate position (X, Y, Z) (e.g., in meters) relative to the center of the WGS-84 ellipsoid and a look or perspective direction specified as a 3D vector also in the same Cartesian space. A 3D projection matrix may be created using this virtual “camera” position and orientation, along with a field of view. The resulting matrix can be used to convert any coordinate on the surface of the earth into screen-space on the user's monitor or screen. This matrix can also be used to create a view frustum, as illustrated in FIG. 6. The view frustum 645 can be visualized as a truncated pyramid 650 extending from a view perspective point 625 along the look or perspective vector 615. The truncated pyramid 650 may define a projection 620 window (e.g., the screen of a device), a near clip plane 610, and a far clip plane 605, successively moving away from the camera position 625 along look vector 615, according to a projection angle 655. The camera position 630 may be located in the plane of the projection window 620, with the camera's look vector 635 pointing upward. The camera's target 640 may be located along the look vector 615 between the near clip plane 610 and the far clip plane 605.

The view frustum 645 may be intersected with the WGS-84 ellipsoid. The point where the view frustum 645 intersects the ellipsoid can be converted into Mercator coordinates, starting with the root tile in the Mercator tile system. The corners of the Mercator tile may be mapped back into screen space using the projection matrix. The total number of screen pixels occupied is then calculated. If the number of screen pixels is greater than a threshold, the number of tiles may be reduced (e.g., tiles combined). The threshold may be the approximate size of the texture used to color the mesh. For most tiles, this is a 256×256 bitmap. Accordingly, if the screen extent is less than 64 k pixels, the tile will be subdivided. The Mercator tile is divided into its 4 child tiles, and the process is repeated for each tile. If subdivided tiles are on the opposite side of the earth from the virtual camera, they may be discarded. The result of this process is that when the virtual camera is close to the earth, high detail tiles that cover less physical ground are selected, and when the camera is farther away, lower-detail tiles that cover greater spaces are selected. In some aspects, tiles from multiple levels of detail may be selected in the same scene. If the camera look direction is not pointing straight down towards the center of the earth, then tiles towards the horizon will be farther away from the virtual camera, and so occupy less screen space. This may result in lower-detail tiles being selectively chosen.

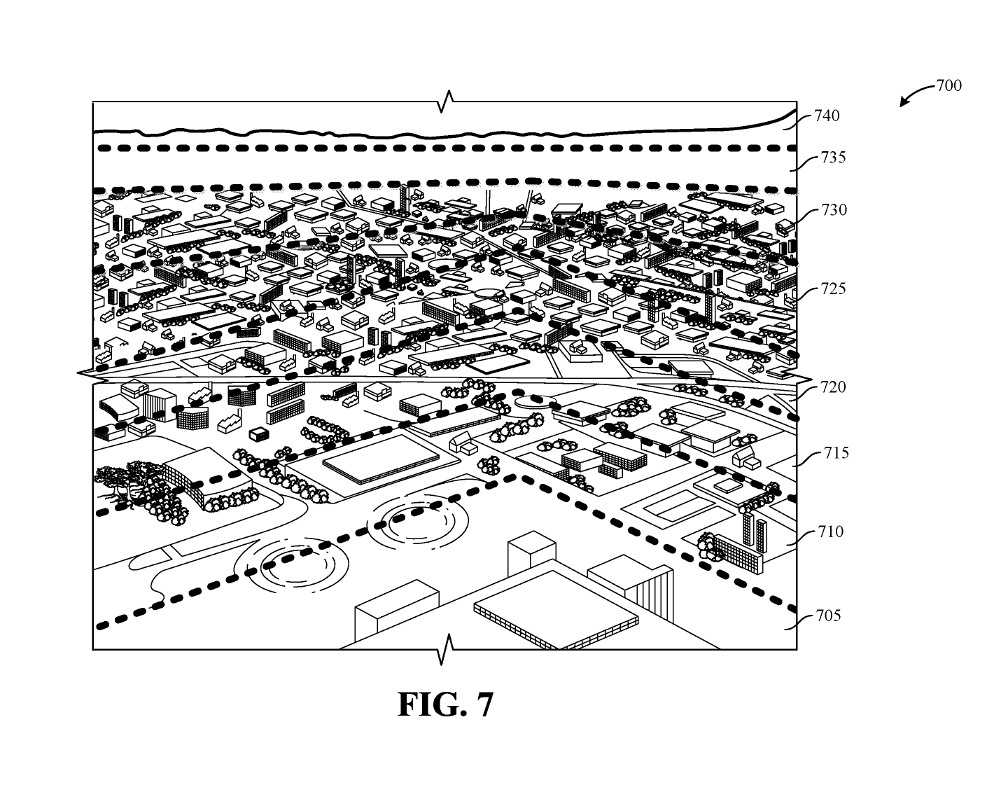

FIG. 7 illustrates an example 700 of map data containing tiles having different resolutions or levels of detail 705-740, selected based on distance from the camera view. Tiles associated with area 705, being closer to a camera view or foreground of the map data, may be selected to have a higher level of detail, whereas tiles associated with areas 740 farther away from the foreground, or point of interest, may be selected to have a lower resolution or show less detail. It should be appreciated that map data 700 is only given by way of example. Resolution of tiles corresponding to different areas of map data, for example, to be translated into a 3D model, may be selected according to various techniques, including based on relative distance to one or more points of interest, data available, distance relative to a horizon associated with the map data, etc. In one example, the resolution of each tile may be selected based on the overall visibility of the tile's contents from all angles of interest and not limited to a certain perspective view of the 3D model. In this way, a visually appealing 3D model may be produced, without having unnecessary or unnoticeable details included in the 3D model. In some aspects, truncating the resolution of the 3D model may enable the generation of 3D models in a faster and more efficient manner, such as by requiring less processor and/or memory resources to generate the model.

In one implementation, tiles that are selected by the rendering algorithm may be output directly to an export format, which is then taken by the 3D builder app and further processed to make it suitable for printing, for example. In other implementations, other, more complex selection processes may be implemented to select geometry for printing. In particular, the level-of-detail falloff used for visual presentation may not be desirable for a printed object where it might be viewed from any angle, thus requiring a consistent level of detail thought the tiles defining the 3D model. The same general principle of determining a general level of detail based on visible surface extent could be used. In other words, the intersection of a view frustum or a user selection (done with mouse drag, touch, pen, gesture input, etc.) on the surface of the earth may be used to determine a general surface extent. That general surface extent could then be used to determine an appropriate tile level of detail to use. The appropriate level of detail selection may take into account the physical size of the final printed object and the resolution of the printer (just like the rendering query uses the pixel extent to determine tile subdivision). The set of included tiles could also include any tiles within the possible output volume, not taking into account simple visibility (so the earth would show up as a full globe when zoomed out). The geometry could be dynamically scaled in the vertical dimension to get height exaggeration, which may be useful for large-area natural features.

In another example, the 3D model may be rendered for use with 3D virtualization systems, including design applications (e.g., to model existing buildings for use with new building design, landscape design, development planning, etc.), devices or applications that provide augmented/full virtual reality, etc. An example device providing augmented or full virtual reality may include a holographic computing device that is configured to render the 3D model as a hologram on a display surface that may also allow visualization of physical real-world elements. In another example, the 3D model may be rendered on an immersive virtual reality system. In some embodiments, the user may be enabled to navigate through and around portions of the rendered 3D model.

In some examples, it may be desirable, as described above, to vary the level of detail translated into one or more tiles of the virtual 3D model (e.g., to speed up processing of the application or device, reduce memory resources needed to store or render the 3D model, etc.). In other cases, it may be desirable to include full detail in the 3D model, such that each tile has the same resolution, for example. In one such example, the 3D model may be generated to include detail visible inside a structure or building, for example, from the outside of the building or structure, such as through one or more windows. This detail may be obtained from the map data, or may be obtained from other data sources and added to the 3D model.

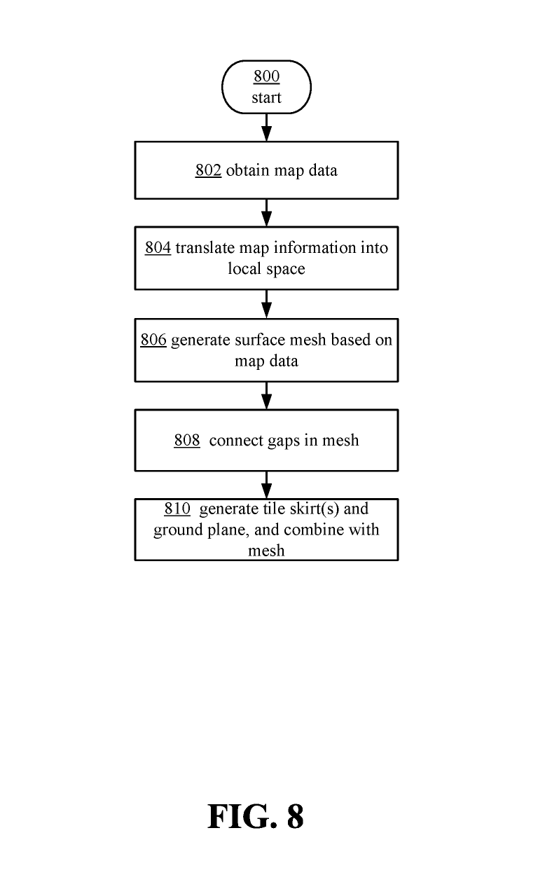

FIG. 8 illustrates an example process for translating map data into a 3D model. Process 800 may begin at operation 802, where map data may be obtained, for example, by a 3D modeling application running on a client device. The map data, as described above, may include WGS-84 data, Mercator coordinate data, and image or other data defining a surface or other features of a map area. The obtained map information may be translated into a local space at operator 804. Operation 804 may include, determining tile boundaries, rotating the tiles to match a 3D modeling coordinate system, and/or adjusting frustum and/or back culling of the data, as detailed above. Next, operation 806 may include generating a surface mesh based on the translated map data. The gaps or holes of data in the surface mesh may then be connected or filled in at operation 808, for example, by using proximate color, texture, height, and other information to extrapolate surface features of the hole or gap. Next, tile skirts may be generated and combined with the mesh to form a full 3D model of map data at operation 810.

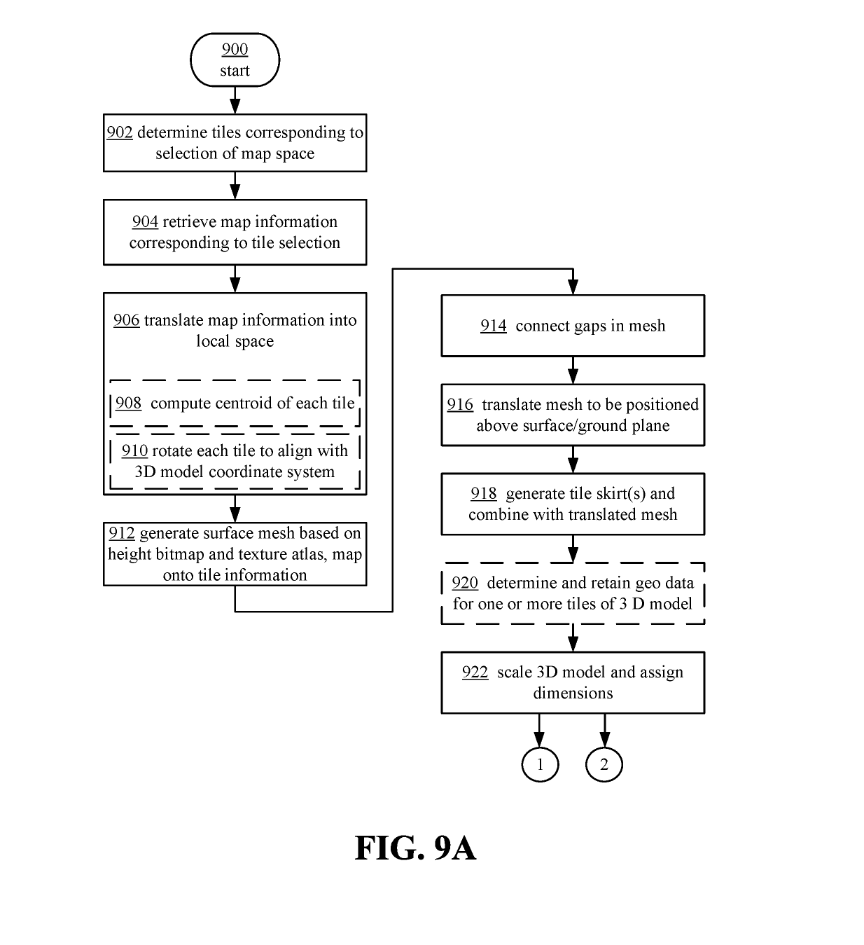

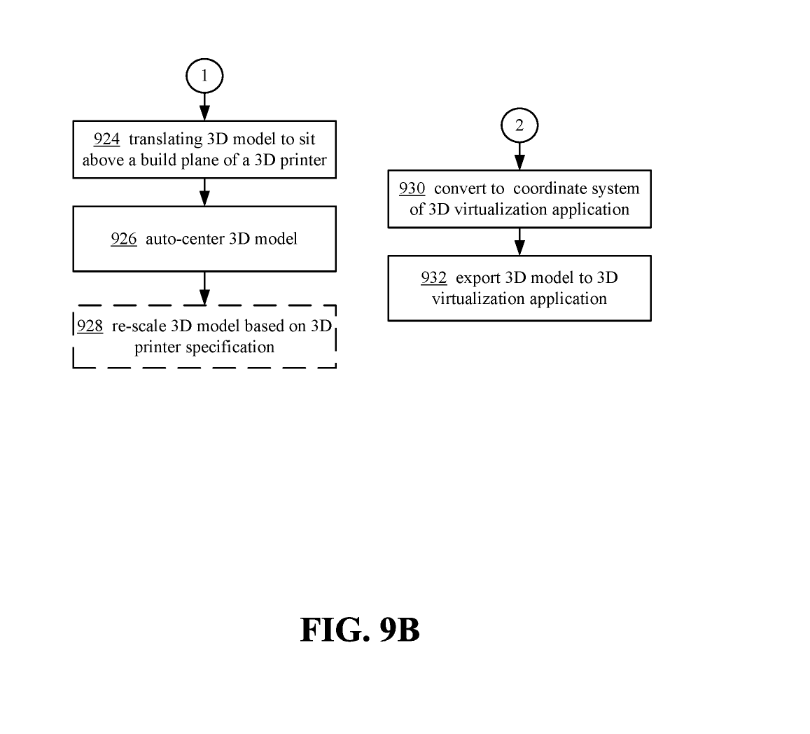

FIGS. 9A and 9B illustrate a more detailed example process 900 for translating map data into a 3D model. Process 900 may begin at operation 902, with determining tile information corresponding to a selection of a map area or space. The selection of a map area may be received via one or more user selection events, for example, via a 3D modeling application running on a client device. The user selection event may include receiving a selection of an area of map data displayed in a user interface of the 3D modeling application (or other mapping application), for example, via any of manual selection, a touch event, a gesture event, etc. In some aspects, the selection event may simply be a selection to create a 3D model. In this scenario, the 3D modeling application may automatically select a portion of map data to use in generating a 3D model. The automatic selection may be based on a centroid of the map data currently displayed by the user interface of the 3D modeling application, an area around the centroid, zoom information selected via the user interface associated with a view of the map area, perspective or camera angle of a view of the map area, other information such as boundaries of roads, buildings, etc., and various other data. The map area selection may then be compared to map data, such as Mercator coordinate data, WGS 84 data, or other data, to determine tiles corresponding to the selected map area.

Next, at operation 904, map information corresponding to the identified tile selection may be retrieved or accessed. In one example, zoom information may be used to select an appropriate resolution or level of detail of data to use in generating the 3D model. For example, if the area selected in the map is a large area, information of the selected area may be selected based on a lower resolution. Alternatively, if the area selected in the map is a small area, information of the selected area may be selected based on a higher resolution.

At operation 906, the obtained map data may be translated into local space for 3D modeling. In one example, the translation may include computing the centroid of each tile corresponding to the selected map area at operation 908. Next, each tile may be rotated about the centroid to align with a 3D modeling coordinate system at operation 910, such as including a standard or default orientation, orientation based on the perspective or camera angle associated with the map data that was selected, or other orientation or coordinate system. In some aspects, all the selected map tiles may be rotated about a common or group centroid to align the tiles with a 3D modeling coordinate system.

A surface mesh may then be generated based on the obtained map data at operation 912. The map data may include a height bitmap (e.g., corresponding to terrain features in less populated areas), a texture atlas (e.g., corresponding to buildings or other features in more populated areas), color information, information relating to or defining objects identified in the map data, etc. The mesh data may be mapped or aligned with the tiles corresponding to the selected map area/space (e.g., combined with coordinate information).

Next, at operation 914, the gaps or absences of data in areas of the mesh may be connected or filled-in using color, texture, and other information of areas proximate to the holes or gaps, as described in more detail above, to create a manifold mesh.

At operation 916, the manifold mesh may be translated or otherwise positioned above a surface or ground plane. In the 3D printing example, this may include a build surface of the 3D printer, for example.

Next, at operation 918, tile skirts may be generated and combined with the translated mesh and surface or ground plane. This operation may yield a fully enclosed volume that defines the bounds of the 3D model. In one example, by first generating a ground plane and aligning it with the manifold mesh, and then adding tile skirts, a clean shell may be generated around the base of the tile or tiles. The translation may preserve the orientation of the top surface to more accurately represent elevation from the original data.

In some implementations, process 900 may also include operation 920, which may include determining and retaining geo data for one or more tiles of the generated 3D model. The geo data may include latitude and longitude information (e.g., for use with GPS), or other information, for example, for use in linking or archiving past 3D models for easier access. In some cases, the geo data may include location information specific to certain map data (e.g., Mercator coordinate information). The geo data may include or be associated with the centroid of one or more tiles in the model, or may be associated with other information, such as used in land surveys, etc. The 3D model may be scaled at operation 922 and assigned dimensions, for example, that represent real-world physical dimensions. The scaling may be indicated by a scale factor (e.g., 1:2000), for example, on the 3D model.

Upon completion of operation 922, the 3D model of a selected map area may be fully configured, and may be exported to a 3D printer, exported to a 3D virtualization application, program, or device, and/or may be edited via a user interface provided by the 3D modeling application or another application. In one example, process 900 may continue to operation 924, as illustrated in FIG. 9B. Operation 924 may include translating the 3D model to be positioned above a build plane of a 3D printer, for example, according to specifications of the 3D printer. Next, the 3D model may be auto-centered, for example, to enable printing by a 3D printer. In some aspects, the 3D model may be re-scaled (if necessary) based on 3D printer specifications at operation 928, for example, to a scale of millimeters to enable printing. In some aspects, one or more of operations 924, 926, and 928 may be performed by the 3D modeling application, the 3D printer, or a combination thereof. In another example, the 3D model may be converted to a coordinate system/re-formatted for a 3D virtualization application, such as one that provides full or augmented virtual reality, at operation 930. The converted 3D model may then be exported to a 3D virtualization application at operation 932.

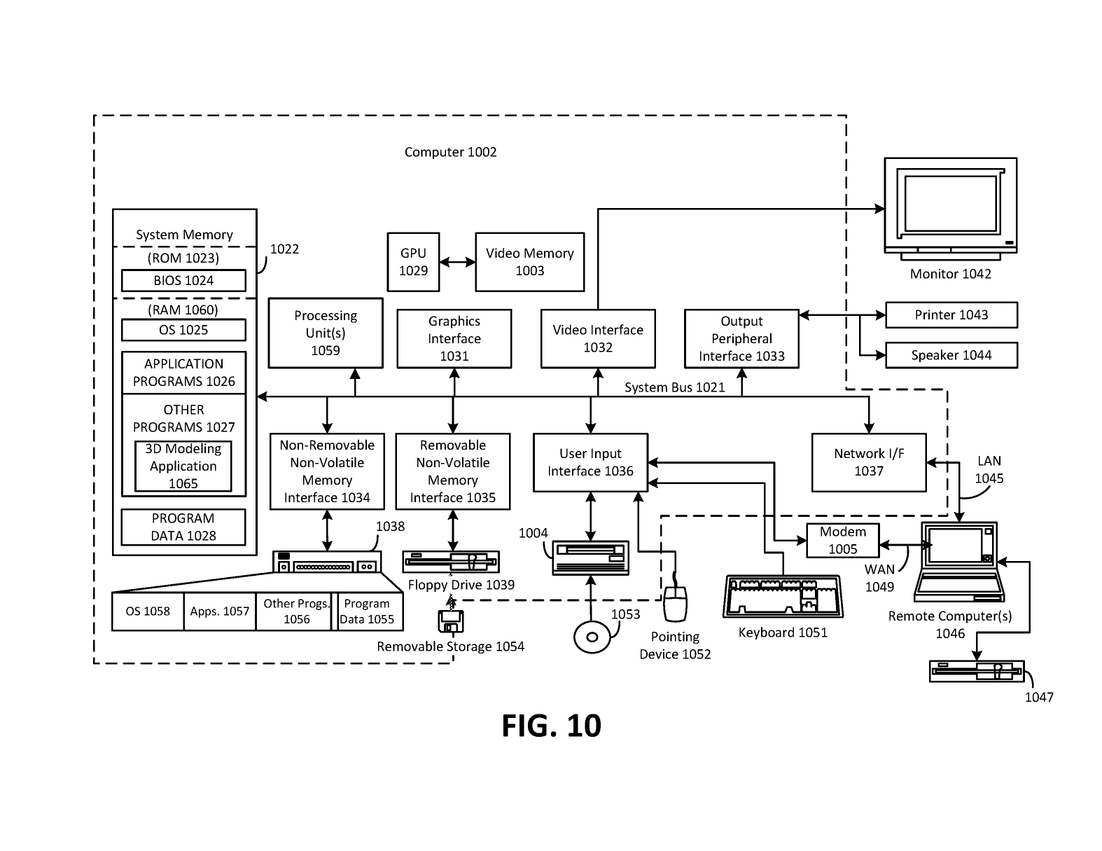

The 3D model application 235, the mapping application 205, and the techniques described above may be implemented on one or more computing devices or environments, as described below. FIG. 10 depicts an example general purpose computing environment in which in which some of the techniques described herein may be embodied. The computing system environment 1002 is only one example of a suitable computing environment and is not intended to suggest any limitation as to the scope of use or functionality of the presently disclosed subject matter. Neither should the computing environment 1002 be interpreted as having any dependency or requirement relating to any one or combination of components illustrated in the example operating environment 1002. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 1002, which may include any of a mobile device or smart phone, tablet, laptop, desktop computer, etc., typically includes a variety of computer-readable media. Computer-readable media can be any available media that can be accessed by computer 1002 and includes both volatile and nonvolatile media, removable and non-removable media. The system memory 1022 includes computer-readable storage media in the form of volatile and/or nonvolatile memory such as read only memory (ROM) 1023 and random access memory (RAM) 160. A basic input/output system 1024 (BIOS), containing the basic routines that help to transfer information between elements within computer 1002, such as during start-up, is typically stored in ROM 1023. RAM 1060 typically contains data and/or program modules that are immediately accessible to and/or presently being operated on by processing unit 1059. By way of example, and not limitation, FIG. 10 illustrates operating system 1025, application programs 1026, other program modules 1027, and program data 1028.

The computer 1002 may also include other removable/non-removable, volatile/nonvolatile computer storage media. By way of example only, FIG. 10 illustrates a hard disk drive 1038 that reads from or writes to non-removable, nonvolatile magnetic media, a magnetic disk drive 1039 that reads from or writes to a removable, nonvolatile magnetic disk 1054, and an optical disk drive 1004 that reads from or writes to a removable, nonvolatile optical disk 1053 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 1038 is typically connected to the system bus 1021 through an non-removable memory interface such as interface 1034, and magnetic disk drive 1039 and optical disk drive 1004 are typically connected to the system bus 1021 by a removable memory interface, such as interface 1035.

The drives and their associated computer storage media discussed above and illustrated in FIG. 10, provide storage of computer-readable instructions, data structures, program modules and other data for the computer 1002. In FIG. 10, for example, hard disk drive 1038 is illustrated as storing operating system 1058, application programs 1057, other program modules 1056, and program data 1055. Note that these components can either be the same as or different from operating system 1025, application programs 1026, other program modules 1027, and program data 1028. Operating system 1058, application programs 1057, other program modules 1056, and program data 1055 are given different numbers here to illustrate that, at a minimum, they are different copies. A user may enter commands and information into the computer 1002 through input devices such as a keyboard 1051 and pointing device 1052, commonly referred to as a mouse, trackball or touch pad. Other input devices (not shown) may include a microphone, joystick, game pad, satellite dish, scanner, or the like. These and other input devices are often connected to the processing unit 1059 through a user input interface 1036 that is coupled to the system bus 1021, but may be connected by other interface and bus structures, such as a parallel port, game port or a universal serial bus (USB). A monitor 1042 or other type of display device is also connected to the system bus 1021 via an interface, such as a video interface 1032. In addition to the monitor, computers may also include other peripheral output devices such as speakers 1044 and printer 1043, such as a 3D printer, which may be connected through a output peripheral interface 1033.

The computer 1002 may operate in a networked environment using logical connections to one or more remote computers, such as a remote computer 1046. The remote computer 1046 may be a personal computer, a server, a router, a network PC, a peer device or other common network node, and typically includes many or all of the elements described above relative to the computer 1002, although only a memory storage device 1047 has been illustrated in FIG. 10. The logical connections depicted in FIG. 10 include a local area network (LAN) 1045 and a wide area network (WAN) 1049, but may also include other networks. Such networking environments are commonplace in offices, enterprise-wide computer networks, intranets and the Internet.

When used in a LAN networking environment, the computer 1002 is connected to the LAN 1045 through a network interface or adapter 1037. When used in a WAN networking environment, the computer 1002 typically includes a modem 1005 or other means for establishing communications over the WAN 1049, such as the Internet. The modem 1005, which may be internal or external, may be connected to the system bus 1021 via the user input interface 1036, or other appropriate mechanism. In a networked environment, program modules depicted relative to the computer 1002, or portions thereof, may be stored in the remote memory storage device. By way of example, and not limitation, FIG. 10 illustrates remote application programs 1048 as residing on memory device 1047. It will be appreciated that the network connections shown are example and other means of establishing a communications link between the computers may be used.

In some aspects, other programs 1027 may include a 3D modeling application 1065 that includes the functionality as described above. In some cases, the 3D modeling application 1065 may execute process 800 or 900, as described above, and provide a user interface, as described above in FIGS. 1, 2A, 2B, and/or 2C above, through graphics interface 1031, video interface 1032, output peripheral interface 1033, and/or one or more monitors or touch screen devices 1042. In some aspects, the 3D modeling application 1065 may communicate with 3D printer 1043 to produce a physical 3D model of map data. In some aspects, other programs 1027 may include one or more 3D virtualization applications that may obtain and provide images that may be displayed of 3D models generated by 3D modeling application 1065.

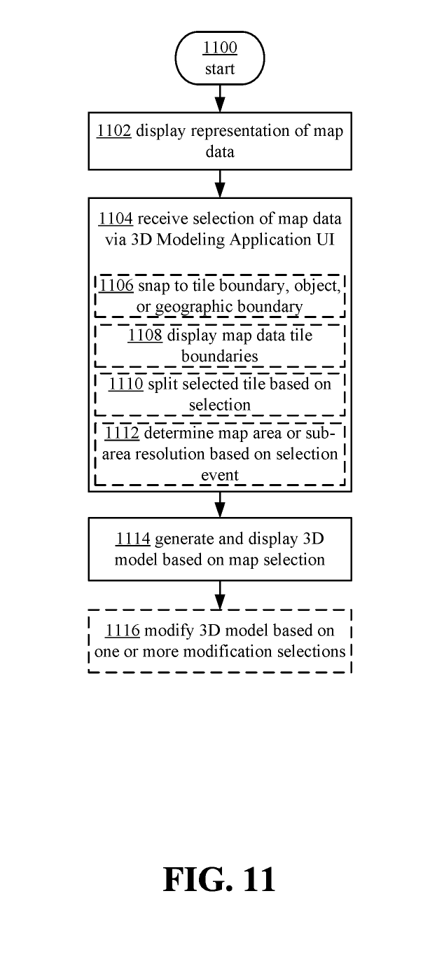

FIG. 11 illustrates an example process 1100 for generating and modifying a 3D model based on a selection of map data via a user interface provided by 3D modeling application 235. Process 1100 may begin at operation 1102, where a representation of map data may be displayed, such as map data 210, via a user interface, which may include user interface 235 described above. Next, at operation 1104, a selection of map data for translation into a 3D model may be received by the user interface. Operation 1104 may include one or more of operations 1106-1112, such as operation 1106, which includes snapping to or automatically pre-selecting one or more of a tile boundary, an object, or a geographic boundary as a boundary of a map area to be translated into a 3D model. Additionally or alternatively, operation 1104 may include operation 1108, in which map tile boundaries or other organizational unit boundaries of the map data may be displayed, for example, to enable intuitive selection of pre-defined areas for generating a 3D model. Additionally or alternatively, operation 1104 may include operation 1110, in which a selected tile may be split into multiple tiles, for example, to enable individual creation or editing of a 3D model generated based on one of the sub-tiles. Operation 1104 may further include operation 1112, in which resolution of an area or sub-area of selected map data may be determined based on a received selection, for example, to reduce the amount of detail that is included in the model where that detail may not be readily apparent in a 3D model or virtualization.

Upon receiving a selection of map data, process 1100 may continue to operation 1114, where a 3D model may be generated and displayed according to the map data selection, as described in further detail above. In some cases, the 3D model may be modified based on one or more user selection or configuration events, at operation 1116. Upon conclusion of the configuration and generation of the 3D model, the model may be exported and printed, for example, using a 3D printer, or may be exported to a 3D virtualization application.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the disclosure. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of certain of the disclosure.

What is claimed is:

1. A system for generating a three-dimensional (3D) model based on selected map data, the system comprising a processor and memory, the system programmed to perform the following operations:
generate a graphical user interface;
display, via the graphical user interface, a visual representation of map data in a first area, wherein the map data comprises at least one map tile having a map tile edge;
receive, through a selection tool of the graphical user interface, data indicative of a selection of the map data;
modify the received selection of the map data to correspond to at least one of a boundary, an object, or the map tile edge in the map data;
generate a 3D model of the modified selection of the map data; and
display, through the graphical user interface, the 3D model of the modified selection of the map data.

2. The system of claim 1, further comprising a 3D printer configured to print the 3D model.

3. The system of claim 1, wherein modifying the received selection of the map data further comprises:
modifying the received selection of the map data concurrently with receiving the selection of the map data.

4. The system of claim 3, wherein modifying the received selection of map data concurrently with receiving the selection of the map data further comprises automatically moving the selection tool to the at least one of the boundary, the object, or the map tile edge.

5. A method for generating a three-dimensional (3D) model based on selected map data, the method comprising:
displaying, on a display device by a graphical user interface, a visual representation of map data;
receiving, by the graphical user interface, a selection of the map data via a selector;
modifying the selection of the map data to correspond to at least one of a boundary or an object in the map data;
generating a 3D model of the modified selection of the map data; and
displaying, by the graphical user interface, the 3D model of the modified selection of the map data.

6. The method of claim 5, wherein the map data comprises at least one map tile having a map tile edge, and wherein the at least one boundary comprises the map tile edge.

7. The method of claim 6, wherein modifying the received selection of the map data further comprises:
modifying the received selection to include one or more complete map tiles of the at least one map tile.

8. The method of claim 5, wherein modifying the received selection of the map data further comprises:
modifying the received selection of the map data concurrently with receiving the selection of the map data.

9. The method of claim 8, wherein modifying the received selection of map data concurrently with receiving the selection of the map data further comprises automatically moving the selector to the at least one of the boundary or the object.

10. The method of claim 8, wherein the map data comprises at least one map tile having a map tile edge, and wherein modifying the received selection of map data concurrently with receiving the selection of the map data further comprises automatically moving the selector to the boundary or the object.

11. The method of claim 5, further comprising:
identifying the at least one of the boundary or the object from the map data.

12. The method of claim 5, wherein the map data comprises at least one map tile having a map tile edge, the method further comprising:
displaying, by the graphical user interface, the map tile edge of the at least one map tile with the visual representation of the map data.

13. The method of claim 5, wherein the selector comprises one of a pointer or a cursor, a touch location on a touch screen, or a bounding shape defining an area.

14. The method of claim 5, further comprising:
receiving, by the graphical user interface, a user selection comprising an adjustment to the 3D model;
adjusting the 3D model based on the received user selection; and
displaying, by the graphical user interface, the adjusted 3D model.

15. The method of claim 5, further comprising:
generating, by a 3D printer, the 3D model.

16. The method of claim 5, wherein receiving the selection of the map data via the selector further comprises:
determining the selection of the map data based on a central portion of the visual representation of map data displayed by the graphical user interface.

17. A computer readable storage medium having stored thereon instructions that, upon execution by at least one processor, cause the at least one processor to perform operations for generating a graphical user interface for receiving a selection of map data to generate a three-dimensional (3D) model based on the selected map data, the operations comprising:
displaying a visual representation of map data;
receiving a selection of the map data via a selector;
modifying the received selection of the map data to correspond to at least one of a boundary or an object in the map data;
generating a 3D model of the modified selection of the map data; and
displaying the 3D model of the modified selection of the map data.

18. The computer readable storage medium of claim 17, wherein the map data comprises at least one map tile having a map tile edge, wherein the at least one boundary comprises the map tile edge, and wherein the operations for modifying the received selection of the map data further comprise operations for:
modifying the received selection to include one or more complete map tiles of the at least one map tile.

19. The computer readable storage medium of claim 17, wherein the operations further comprise:
modifying the received selection of map data concurrently with receiving the selection of the map data.

20. The computer readable storage medium of claim 19, wherein the operations for modifying the received selection of map data concurrently with receiving the selection of the map data further comprise operations for:
automatically moving the selector to the at least one of the boundary or the object.
